(19) United States
(12) Patent Application Publication
(10) Pub. No.: US 2010/0109910 A1
(43) Pub. Date: May 6, 2010

(54) PORTABLE INFORMATION/WARNING SYSTEM

(76) Inventor: Michael P. Fahey, Clifton Park, NY (US)

Correspondence Address: SCHMEISER, OLSEN & WATTS, 22 CENTURY HILL DRIVE, SUITE 302, LATHAM, NY, 12110, US

(21) Appl. No.: 12/266,142

(22) Filed: Nov. 6, 2008

(51) Int. Cl. G08G 1/09; G08B 5/00

(52) U.S. Cl. 340/908; 340/815.4

(57) ABSTRACT

A Portable Information/Warning System includes a trailer, a battery-powered electronic changeable message board, an emergency light bar and a solar panel coupled to the electronic changeable message board over the emergency light bar. The emergency light bar comprises multiple alternately-flashing color lights. Alternate embodiments include the trailer being couplable to a vehicle, the message board being programmable with a variety of messages, and the angle of the solar panel being adjustable. The message board may also be configured to supply power to the emergency light bar. A method for informing passing traffic of hazards or obstructions including moving a portable information/warning system to a location which traffic will pass prior to said hazard or obstruction; programming said portable information/warning system to display a message if desired; programming said portable information/warning system's emergency light bar to flash if desired; and leaving said portable information/warning system unattended after activation.

### BACKGROUND OF THE INVENTION

1. Technical Field

This invention relates to a portable information/warning system for capturing the attention of or alerting drivers and for providing important information to drivers concerning hazards or obstructions and the like.

2. Background Art

In order to inform drivers and others of potential hazards or obstructions, municipal, state and federal government agencies often use law enforcement personnel to slow or stop the flow of traffic in response to road construction, accidents or because of inclement weather. This is usually accomplished by stationing police officers in vehicles on site, with emergency lights flashing, for the duration of the time period required for traffic control. The vehicles' emergency lights remain activated as a warning to oncoming motorists that they are approaching a potential problem situation that requires that they immediately reduce their speed. The flashing emergency lights, which are immediately discernible from a considerable distance, are extremely effective as they are universally recognized as an indication of caution and warning.

Portable sign systems are also frequently used by roadway construction crews to inform drivers of delays or detours. These systems typically utilize digital display panels that are mounted on trailers or the like. Messages displayed by these systems, however, may easily be overlooked by drivers. Examples of these systems can be found in the following patents and applications.

U.S. Pat. No. 6,972,689 to Morgan et al. discloses a portable sign system with a digital display panel. Morgan et al. discloses that the portable sign system has a trailer and trailer frame. Components are mounted to the trailer frame to provide a portable sign system.

U.S. Pat. No. 6,750,829 to Luoma et al. and U.S. Patent App. Pub. No. 2007/0251132 to Luoma et al. (hereinafter “Louma et al. references”) disclose an Outdoor Changeable Message Sign. Luoma et al. references disclose a mobile sign with a solar panel used to recharge the power source (battery/batteries). Luoma et al. references disclose the sign comprising a multiplicity of LED's in a matrixical arrangement for generating electronically changeable messages. Luoma et al. references disclose that the mounting structure for the sign comprises a trailer having a platform supported by wheels rotatably mounted on the platform.

U.S. Pat. No. 6,101,750 to Blesener et al. discloses changeable displays or changeable message signs used for exhibiting visual written information capable of portraying several sequential segments of information in a complete message and being further selectively programmable to display real time information to motorists and assist in efforts to improve roadway operations and safety.

Though, very useful for providing information to drivers and others, the above patents often fail to capture the attention of drivers effectively enough to prevent accidents and other incidents. Therefore, police officers and vehicles are often required to slow oncoming traffic. This requires significant resources that could be used in other ways. Accordingly, what is needed is a portable information/warning system that captures drivers' attention effectively enough to slow oncoming traffic and prevent the necessity of police officers and vehicles to simply slow traffic.

### DISCLOSURE OF THE INVENTION

The present invention may be readily adapted to a variety of portable information systems. Embodiments of the present invention may provide, among other benefits: a portable information/warning system that captures the attention of drivers effectively and provides necessary information.

In particular embodiments, a Portable Information/Warning System comprises a trailer comprising at least two wheels, a platform and a tongue, wherein said tongue is couplable to a vehicle; an electronic changeable message board coupled to said trailer above said platform, wherein said electronic changeable message board may be programmed with a variety of messages; an emergency light bar operably coupled to the top of said electronic changeable message board, wherein the circuitry of said electronic changeable message board is configured to supply power to said emergency light bar; and a battery-recharging solar panel operably coupled to said electronic changeable message board in a position above said emergency light bar, wherein the angle of said solar panel is adjustable.

Alternate embodiments of the present invention comprise: a trailer; an electronic changeable message board coupled to said trailer; a solar panel operably coupled to said electronic changeable message board; an emergency light bar operably coupled to said electronic changeable message board, wherein an emergency light bar comprises multiple color lights that flash in an alternating pattern; and wherein said emergency light bar is coupled to the top of said electronic changeable message board and below said solar panel.

A method utilizing the present invention comprises: moving a portable information/warning system to a location which traffic will pass prior to said hazard or obstruction; programming said portable information/warning system to display a message if desired; programming said portable information/warning system's emergency light bar to flash if desired; and leaving said portable information/warning system unattended after activation.

The foregoing and other features and advantages of the invention will be apparent to those of ordinary skill in the art from the following more particular description of the invention and the accompanying drawings.

### BRIEF DESCRIPTION OF THE DRAWING

The invention will hereinafter be described in conjunction with the appended drawings where like designations denote like elements, and:

FIG. 1 is a perspective view of a portable information/warning system configured according to an embodiment of the present invention;

FIG. 2 is a front view of a portable information/warning system configured according to an embodiment of the present invention;

FIG. 3 is a perspective view of a portable information/warning system with a solar panel at an alternate angle configured according to an embodiment of the present invention;

FIG. 4 is a perspective view of a portable information/warning system configured according to an alternate embodiment of the present invention;

FIG. 5 is a front view of a portable information/warning system configured according to an alternate embodiment of the present invention; and

FIG. 6 is a method of informing drivers using a portable information/warning system configured according to the present invention.

### DESCRIPTION OF THE INVENTION

As discussed above, embodiments of the present invention relate to a portable information/warning system and method of use. In particular, a portable information/warning system configured according to the present invention effectively attracts the attention of drivers and provides important information to them. Generally, a portable information/warning system configured according to embodiments of the present invention comprise a battery-powered electronic changeable message board, an emergency light bar, a trailer and a solar panel used to recharge the battery/batteries.

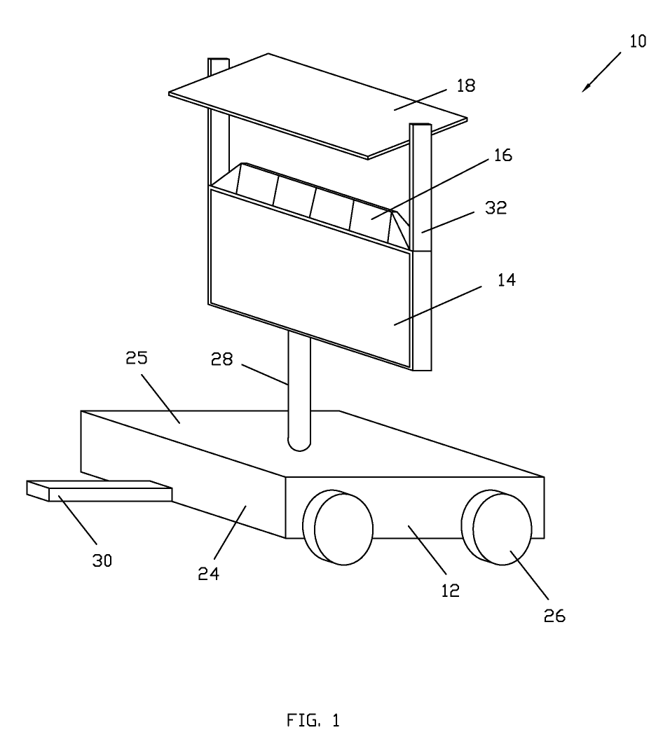

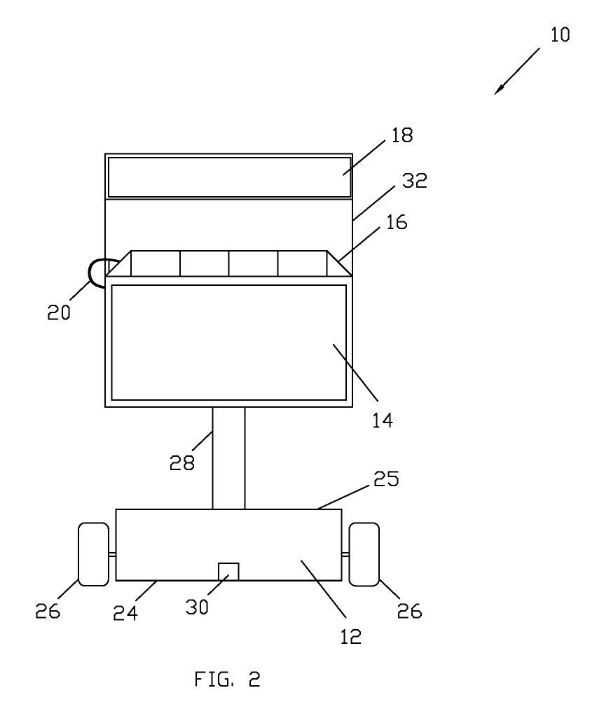

FIGS. 1 through 5 illustrate portable information/warning systems 10 configured according to embodiments of the present invention. Portable information/warning systems 10 configured according to embodiments of the present invention comprise a trailer 12. The trailer 12 may be configured as a platform 24. The platform 24 may have a flat surface on the top 25 which is the surface farthest from the ground when in operation. The top 25 may also be a flat surface with a lip around the edge to allow other items to be carried on the trailer 12 along with the portable information/warning system 10. It is also possible that the platform 24 is shaped as a box with a tall lip for retaining items.

The platform 24 is coupled to at least one wheel 26. Typically a trailer 12 will have at least two wheels 26 which allow the trailer to be mobile. The at least two wheels 26 are coupled to the edges of the platform 24 and are positioned so that they are in contact with the ground. The at least two wheels 26 are also positioned so that they hold the platform 24 above the ground.

The platform 24 may be coupled to a tongue 30. The tongue 30 is configured to connect the trailer 12 to a vehicle such as a truck which will pull the trailer 12 to a desired site. The tongue 30 may be a rectangular piece of material with a means of connecting to a hitch such as a ball hitch at the end of the tongue 30 farthest from the trailer 12. The tongue 30 may also be configured as a triangle with two rectangular pieces of material meeting at a point which would connect to a hitch.

A mounting post 28 is coupled to the platform 24 of the trailer 12. The mounting post 28 may be any size, length or shape, provided it has the strength and durability to support an electronic message board 14. Examples of a mounting post 28 may include a pipe with any shape cross section, such as rectangular, circular or square. Other examples of a mounting post 28 are solid pieces of material with any cross section desired.

The mounting post 28 is coupled on one end to the top 25 of the platform 24 of the trailer 12 while the other end of the mounting post 28 is coupled to an electronic changeable message board 14. An electronic changeable message board 14 as configured in embodiments of the present invention may be any type of electronic changeable message board 14 that is on the market. Electronic changeable message boards 14 are programmable devices that display messages through the use of light. These electronic changeable message boards 14 are designed for informing drivers, during the day or night, of important information concerning roadway conditions. Electronic changeable message boards 14 which may be appropriate for use in the present invention may employ numerous technologies to portray message through light which is bright enough to be seen day or night. This includes electronic changeable message boards 14 that utilize LED technology.

It is anticipated that electronic changeable message boards 14 may be remotely programmable through many different means including by text message and the like. Electronic changeable message boards 14 may also be programmed with multiple messages that may be displayed at different times or dates. The electronic changeable message boards 14 utilized in this invention may also contain preprogrammed messages that may be accessed or may be programmed with a message and then reprogrammed at a later date. Electronic changeable message boards 14 that meet these standards may be found in the prior art as described in the background section of this application.

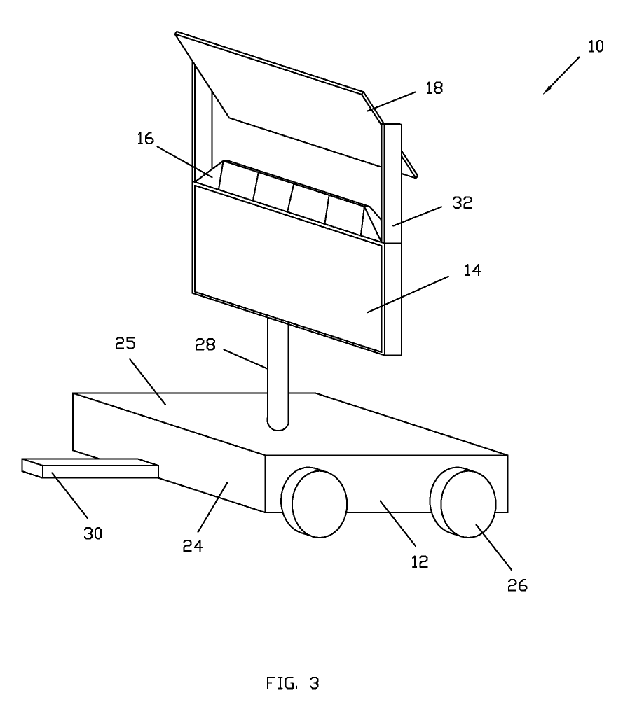

It is also desirable that the electronic changeable message boards 14 of this invention may incorporate a solar panel 18 in order to recharge the battery power source of the portable information/warning system 10. The solar panel 18 may be coupled to a battery (not shown) which would continuously charge in order to provide power to the portable information/warning system 10. The solar panel 18 may be supported by a mounting device 32 which allows the solar panel 18 to swivel along an axis in order to maximize exposure of the solar panel 18 to the sun (see FIG. 3). Swivelling the solar panel 18 may be done manually or it may be done electronically. The solar panel 18 may automatically swivel as the sun moves through the sky in order to maximize sun exposure. The solar panel 18 may also be remotely programmed to reposition or swivel.

Coupled to the top of the electronic changeable message board 14 and below the solar panel 18 (or at least in a position that it does not interfere with the solar panel 18), is an emergency light bar 16. The solar panel 18 should be positioned high enough to allow the emergency light bar 16 to be mounted to the top of the electronic changeable message board 14. The emergency light bar 16, configured according to embodiments of the present invention, may be any emergency light bar available. Preferred embodiments of the emergency light bar 16 may be light bars such as those used on emergency vehicles and in particular emergency light bars 16 such as those used on police vehicles. The colors of the lights used in the emergency light bars 16 on police vehicles are well known to drivers and therefore tend to capture drivers' attention. The emergency light bars 16 of the present invention should utilize multiple colors of lights. The emergency light bars 16 should also flash in alternating patterns. The emergency light bars 16 may have different settings for different patterns of flashing.

It may be desirable for the emergency light bars 16 of the present invention to be remotely programmable via text message or the like.

The emergency light bars 16 of the present invention may be configured to obtain power from the power source of the electronic changeable message board 14. Emergency light bars 16 configured for the present invention may be hardwired to receive power from the electronic changeable message board 14. This hardwiring may include a power cable and a transformer in order to provide power to the emergency light bar 16. The electronic changeable message board 14 may also be configured with an outlet such that it could receive a power cord 20, coupled with a plug, from the emergency light bar 16. This outlet, plug and power cord 20 should be as weather proof as possible.

It is also possible that in alternate embodiments of the present invention, the emergency light bar 16 may receive power directly from the solar panel 18.

A mounting bracket (not shown) may also be required in order to mount the emergency light bar 16 to the electronic changeable message board 14.

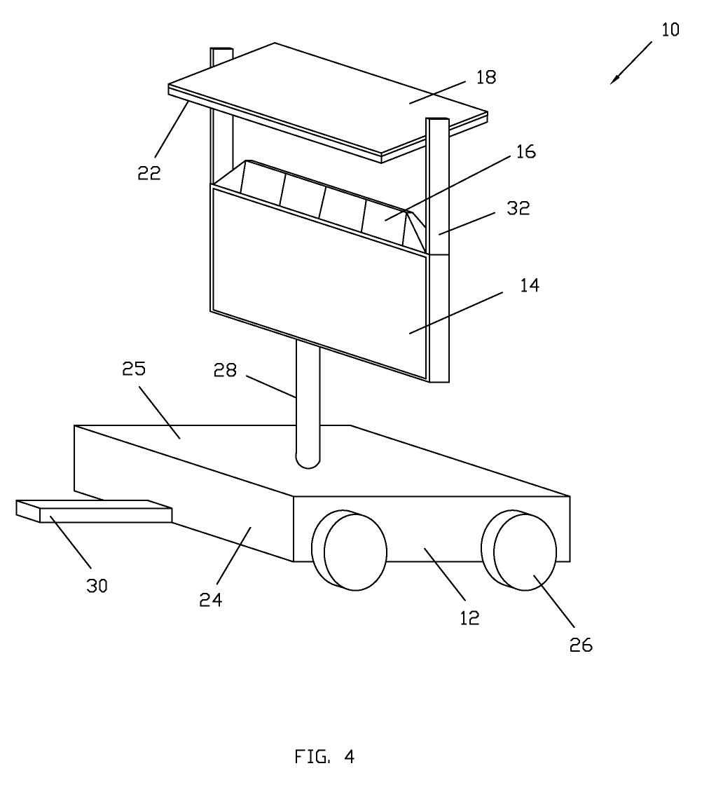

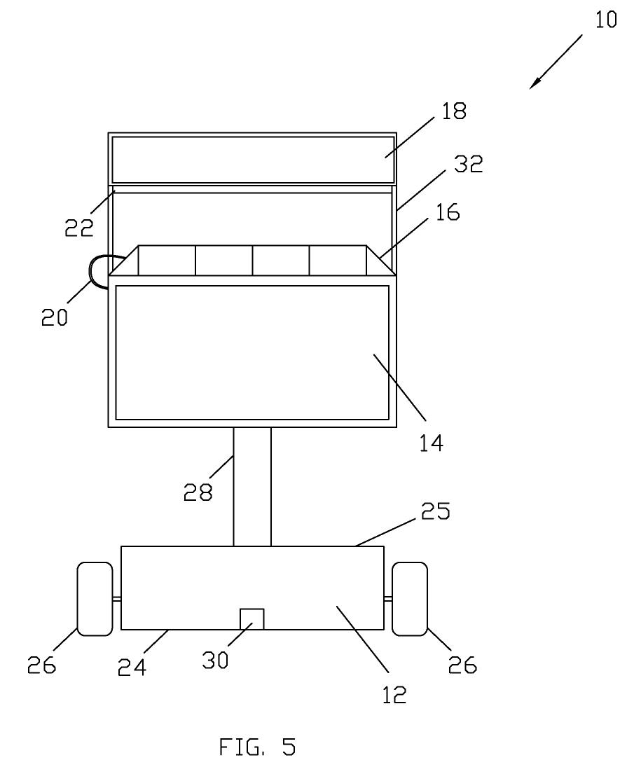

In alternate embodiments of the present invention, as shown in FIGS. 4 and 5, include a cushioning material 22 coupled to the underside of the solar panel 18. The cushioning material 22 would prevent the solar panel 18 from making direct solid contact with the emergency light bar thus precluding possible damage to either component. Other embodiments may include locking mechanism that prevent the solar panel 18 from rotating or bumping into the emergency light bar 16.

Accordingly, for the exemplary purposes of this disclosure, the components defining any embodiment of the invention may be formed as one piece if it is possible for the components to still serve their function. The components may also be composed of any of many different types of materials or combinations thereof that can readily be formed into shaped objects provided that the components selected are consistent with the intended mechanical operation of the invention. For example, the components may be formed of rubbers (synthetic and/or natural), glasses, composites such as fiberglass, carbon-fiber and/or other like materials, polymers such as plastic, polycarbonate, PVC plastic, ABS plastic, polystyrene, polypropylene, acrylic, nylon, phenolic, any combination thereof, and/or other like materials, metals, such as zinc, magnesium, titanium, copper, iron, steel, stainless steel, any combination thereof, and/or other like materials, alloys, such as aluminum, and/or other like materials, any other suitable material, and/or any combination thereof.

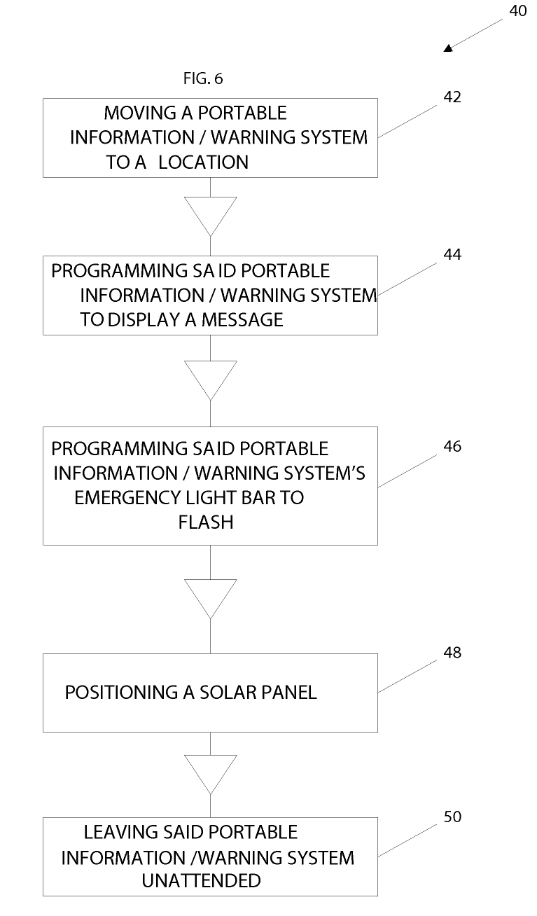

FIG. 6 illustrates a method 40 of using embodiments of the present invention may include moving a portable information/warning system to a desired location 42. Typically this is done by coupling the trailer of the portable information/warning system to a vehicle and towing the portable information/warning system to the appropriate location. An appropriate location to place a portable information/warning system would be prior to a hazard or obstruction, in order to inform drivers. The portable information/warning system should also be positioned far enough away from the hazard or obstruction to allow a driver to slow or stop safely in advance of the hazard or obstruction.

Next, the portable information/warning system may be programmed to display a message if desired 44. This programming may be done directly or remotely. The portable information/warning system may also be programmed not to display a message.

Then the portable information/warning system's emergency light bar may be programmed to flash if desired 46. This may also be done directly or remotely. Different patterns of flashing may also be programmed. The emergency light bar may further be programmed not to flash.

Therefore, the portable information/warning system may be programmed to display a message and flash the emergency light bar, display a message with no flashing emergency light bar or flash the emergency light bar without displaying a message.

Now the solar panel on the portable information/warning system may be positioned 48. This may be done directly or remotely. It is also possible that the position of the solar panel may be programmed to change depending on the position of the sun.

Finally, the activated portable information/warning system may be left unattended 50 in order to warn drivers. The ability to leave the portable information/warning system unattended enables the system to allow emergency personnel and vehicles to be dispatched elsewhere while traffic is still being controlled by the portable information/warning system.

The steps in this method may be performed in any order.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation.

What is claimed is:

1. A Portable Information/Warning System comprising:
a trailer;
a battery-powered electronic changeable message board coupled to said trailer;
a solar panel operably coupled to said electronic changeable message board;
an emergency light bar operably coupled to said electronic changeable message board, wherein an emergency light bar comprises multiple color lights that flash in an alternating pattern; and
wherein said emergency light bar is coupled to the top of said electronic changeable message board and below said solar panel.

2. The Portable Information/Warning System of claim 1, wherein the battery/batteries of said electronic changeable message board provide(s) power to said emergency light bar.

3. The Portable Information/Warning System of claim 1, wherein said solar panel is operably coupled to said electronic changeable message board.

4. The Portable Information/Warning System of claim 1, wherein the electronic changeable message board may be operating while the emergency light bar is operating.

5. The Portable Information/Warning System of claim 1, wherein the electronic changeable message board may operate while the emergency light bar is not operating.

6. The Portable Information/Warning System of claim 1, wherein the emergency light bar may operate while the electronic changeable message board is not operating.

7. The Portable Information/Warning System of claim 1, further comprising cushioning material coupled to said solar panel.

8. The Portable Information/Warning System of claim 1, wherein the electronic changeable message board may be remotely programmable.

9. The Portable Information/Warning System of claim 1, wherein the emergency light bar is remotely programmable.

10. A Portable Information/Warning System comprising:
a trailer comprising at least two wheels, a platform and a tongue, wherein said tongue is couplable to a vehicle;
an electronic changeable message board coupled to said trailer above said platform, wherein said electronic changeable message board may be programmed with a variety of messages;
an emergency light bar operably coupled to the top of said electronic changeable message board, wherein the circuitry of said electronic changeable message board is configured to supply power to said emergency light bar; and
a solar panel operably coupled to said electronic changeable message board in a position above said emergency light bar, wherein the angle of said solar panel is adjustable.

11. The Portable Information/Warning System of claim 10, wherein said Portable Information/Warning System may be moved to a desired location and then left unattended.

12. The Portable Information/Warning System of claim 10, wherein a cushioning material is coupled to the underside of said solar panel.

13. The Portable Information/Warning System of claim 10, wherein said electronic changeable message board further comprises a plug-in receptacle to receive a plug coupled to the power cord of said emergency light bar.

14. The Portable Information/Warning System of claim 10, wherein said Portable Information/Warning System is remotely programmable.

15. A method for informing passing traffic of hazards or obstructions comprising:
moving a portable information/warning system to a location which traffic will pass prior to said hazard or obstruction;
programming said portable information/warning system to display a message if desired;
programming said portable information/warning system's emergency light bar to flash if desired; and
leaving said portable information/warning system unattended.

16. The method of claim 15, further comprising programming said portable information/warning system and said portable information/warning system's emergency light bar from a remote location.

17. The method of claim 15, further comprising positioning a solar panel of said portable information/warning system.

18. The method of claim 15, wherein said portable information/warning system's emergency light bar is programmed not to flash and said portable information/warning system is programmed to display a message.

19. The method of claim 15, wherein said portable information/warning system is programmed not to display a message and said portable information/warning system's emergency light bar is programmed to flash.

20. The method of claim 15, further comprising re-programming said portable information/warning system and said portable information/warning system's emergency light bar from a remote location.
